(19) United States
(12) Patent Application Publication
(10) Pub. No.: US 2021/0277888 A1
(43) Pub. Date: Sep. 9, 2021

(54) Pump for the Application of Fluids

(71) Applicant: Carlos Saravia Castillon, Durango (MX)

(72) Inventor: Carlos Saravia Castillon, Durango (MX)

(21) Appl. No.: 16/334,651

(22) PCT Filed: Oct. 4, 2016
(86) PCT No.: PCT/MX2016/000102

§ 371 Date: Mar. 19, 2019

(30) Foreign Application Priority Data
Oct. 4, 2016 (MX) PCT/MX2016/000102

(51) Int. Cl. F04B 53/10; F04B 53/14; F04B 53/16; F04B 53/18; F04B 49/12; B05B 9/04

(52) U.S. Cl. CPC F04B 53/10; F04B 53/14; B05B 9/04; F04B 53/18; F04B 49/12; F04B 53/16

(57) ABSTRACT

The invention relates to a pump for the application of fluids, which comprises: a piston in which the head (3) of the plunger (1) is surrounded by two packing rings (4) separated from one another to form a channel (5), where a lubricant is added; a tubular case (6) for accommodating the tubular body (2) of the piston; a set of valves provided at the outlet end of the tubular body (2) of the piston, for suctioning and expelling fluids; an elbow (29) connected to the free end of a second valve container (22) to join the set of valves to a first pipe (30) that supplies fluid to the pump; and a second pipe (32) connected to the free end of a third section (18) of a first container (14), for receiving the fluids that exit the piston and transporting same to a nozzle (33) for the final application of the fluid.

### TECHNICAL FIELD OF THE INVENTION

The present invention relates to the technical field of mechanics, more specifically to the area of the mechanisms for supplying fluids, since it provides a pump with which different types of fluid can be applied, either at the same time or at different times; where the fluids can be liquids, thick liquids, gases, or any other type of particle flows, that can be applied with the present pump.

### BACKGROUND OF THE INVENTION

Currently there are already pumps, mechanisms, devices, sprayers, etc., which serve for the application of fluids, either manual or motorized.

Patent document WO2013/151409 describes a suction/ejection pump for applying liquids and/or gases, wherein said pump comprises a suction/ejection mechanism; a clamping mechanism to hold the suction/ejection mechanism; a container of liquids and/or gases, which supplies the mechanism; a hose through which liquids and/or gases move; and a means for holding the container of liquids and/or gases.

The suction/ejection mechanism for supplying liquids or gases, in turn, comprises a primary support bracket, which in turn has a pressure cam placed inside a hole with upper conduit, located a few mm higher than a conduit passed, where these two passages cross each other internally and serve as a guide for a hose, which is pressed by the cam and thus press a flow of material transported internally by the hose; in its lower part it has a fastening system similar to the sliding and any other type of female and male; a secondary support bracket, with the same configuration to the primary support, through which the hose will pass until it is connected to a liquid or gas inlet nozzle, which is a tube that on the outside has small retaining projections that serve as hose pressure holders; said nozzle is attached to a piece, preferably in a circular form called the valve body that has two internal cylindrical cavities, one inlet and one outlet, which also have two small projections that serve to thin the outlets of some cavities, allowing with this, that when they are inserted, at least, a pair of inverted duckbill valves, metallic pellets, membrane or any other type of valve, you are only have a limit of internal movement, and the flow of liquids or gases, exerts a greater internal pressure, being expelled towards an exit nozzle, which is coupled another section of hose that will serve to attach to any other mechanism such as a brush, roller, liquid sprinkler, nebulizer or a pivot to inflate tires, balloons, and/or balloons; an elongated piece, of tubular shape and passed internally, called internal container is where the valve body is coupled, and this is where the liquids or gases are deposited to be expelled; said inner container has at its left end a circular projection on its external part and on the other right has a circular internal projection, in addition to two internal channels that run through the body of the internal container.

Said suction/ejection mechanism, also has a pumping cavity, where the internal container is inserted, which is of cylindrical body and in its internal part is smooth and slightly larger than the internal container. This pumping cavity has a circular projection with two grooves of the same size as the channels of the internal container. Said circular projection is placed more to the right of the cylindrical body of the cavity, which will serve as the first function to limit and attach to the internal container for its right end, and as a second function is to limit the stroke of a piston; in the upper internal part of the cylindrical body of the pumping cavity there is a small cavity for receiving a metallic tip or any material of the lamella of the securing latch of an ergonomic handle; in the left part of the pump cavity on the outside of its body, it has a threaded section, in which the valve body will be coupled, both parts will be subjected to pressure by a union nut in order to join these two parts and inhibit the escape of liquids or gases; In the lower right part of the pumping cavity a section forming the secondary holding support is projected.

The piston is manufactured in a single cylindrical piece that has a threaded area on its right end, its central part is smooth, and on the left side it has two projections or guides on each of its sides. At the beginning of the left side it is coupled circular piece, to which will be attached a rubber gasket made of material resistant to friction or abrasion of liquids or gases, and has a dosing nut attached that allows the piston to slide. The piston passes through a threaded conduit that is in the upper part of the primary support, remaining firm and aligned inside the pumping cavity, where the circular piece, together with the packing, will meet the internal part of the internal container.

The ergonomic handle has in its upper part a clamping button, inserted in a hole, the clamping button has a safety system that is a metal or any material tip and a securing clamp lamella.

The drawbacks of the pump of this document WO2013/151409, are that each time an attachment has to be changed, the user must use a screwdriver to loosen the outlet hose's clamp, disconnect the hose, change the attachment, reconnect the hose with a screwdriver, re-tighten its clamp, and tighten the new attachment, which sometimes remains in an uncomfortable or unusable position. The body of this pump is one piece, which complicates and makes it much more expensive to assemble and disassemble.

On the other hand, all molding pieces in injected plastic have certain conicity, so the interior of the body of said pump (WO2013/151409) are not really straight, but conical and there is a risk of spills because the internal diameter of said pump is variable.

Due to the aforementioned drawbacks, a pump was developed for the application of different types of fluids, which is described below.

### BRIEF DESCRIPTION OF THE FIGURES

FIG. 1 is an exploded view of the pump for the application of fluids, according to the present invention.

FIG. 2 is a conventional perspective view of the piston that is part of the pump of the present invention.

FIG. 3 is a longitudinal section of the carcass that is part of the pump in question.

FIG. 4 is an exploded perspective view of the valve assembly of the pump of the present invention.

FIG. 5 is a conventional perspective view of the union of a tubular part and the outlet valve of the pump in question.

FIG. 6 is a longitudinal section of the section where the union of the valve assembly with the piston, of the pump in question.

FIG. 7 is a conventional perspective view of the pump, according to the present invention.

FIG. 8 is an exploded perspective view of one embodiment of the valve assembly of the pump of the present invention.

FIG. 9 is a conventional perspective view in one of the embodiments of the first valve container (14) of the pump of the present invention.

FIG. 10 is a cross section of the valve assembly of the embodiment illustrated in FIG. 8, but in a structured condition.

FIG. 11 is a longitudinal section of the valve assembly of the embodiment illustrated in FIG. 8, but in a structured condition.

FIG. 12 is a conventional perspective view of a flow controlling part that is part of the valve assembly of the pump of this invention.

FIG. 13 is a front view of the flow controlling part illustrated in the previous figure.

FIG. 14 is a rear view of the flow controlling part illustrated in FIG. 12.

FIG. 15 is a rear perspective view of a piece-seal (75) which controls the flow of fluids in the flow controlling part (47).

FIG. 16 is a side view of the seal piece (75) of the previous figure.

FIG. 17 is a front perspective view of the seal piece (75).

FIG. 18 is a rear view of the seal piece (75).

FIG. 19 is a conventional perspective view of the assembly between the flow controlling part (47) and the seal part (75).

FIG. 20 is a conventional perspective view of the head (3) of the piston, where a protrusion (81) for the closing of the peripheral perforations and cavity (79) of the seal piece (75) is observed.

FIG. 21 is an explosive view showing the interaction of the elements, the controlling part (47) of the flow of the fluids, the part-seal (75) and the head (3) of the piston (1), of the bomb.

FIG. 22 is a longitudinal section of a section where the valve assembly and the connection to the piston outlet of the modified pump are in an assembled condition.

FIG. 23 is a side view of the pump of the present invention, in its embodiment with several inlet valves, in a fully assembled condition.

FIG. 24 is a longitudinal section of the second fastening means in its modified version, in an explosive condition.

FIG. 25 is a longitudinal section of the second fastening means, according to the previous figure, but in an assembled condition.

FIG. 26 is an explosive perspective view of the front part of the second fastening means (35), to observe in detail the configuration of its front end, to receive the stop-piece (84).

FIG. 27 is a conventional perspective view of the front part of the second holding means (35), in a condition assembled with the stopper (84).

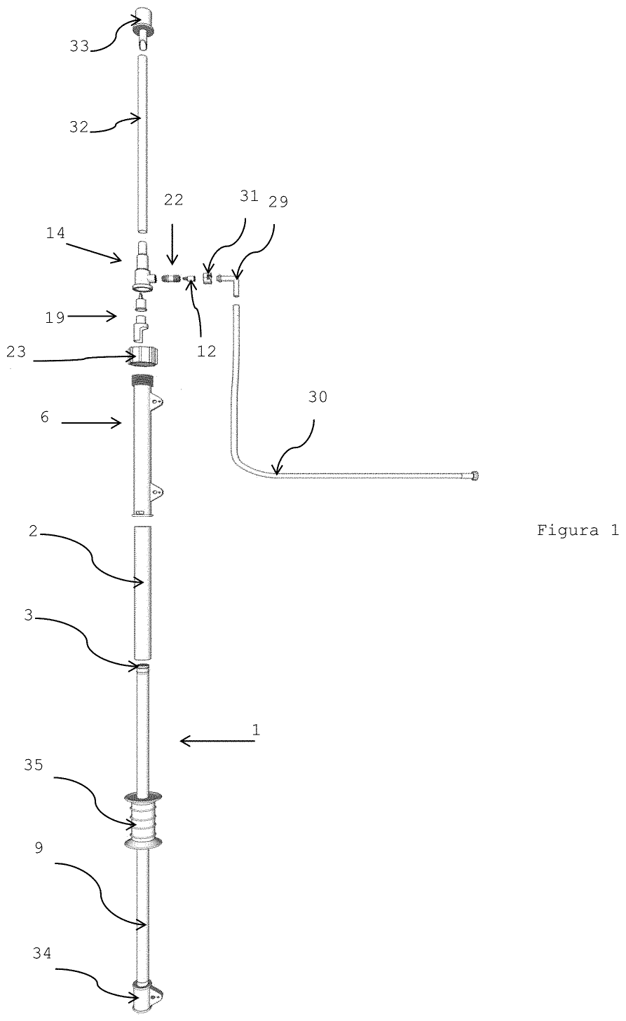

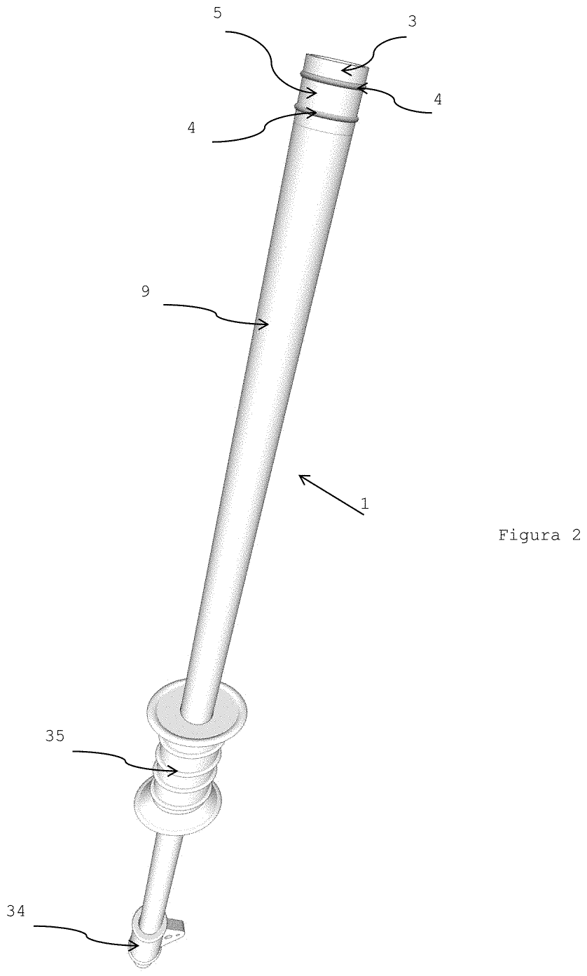

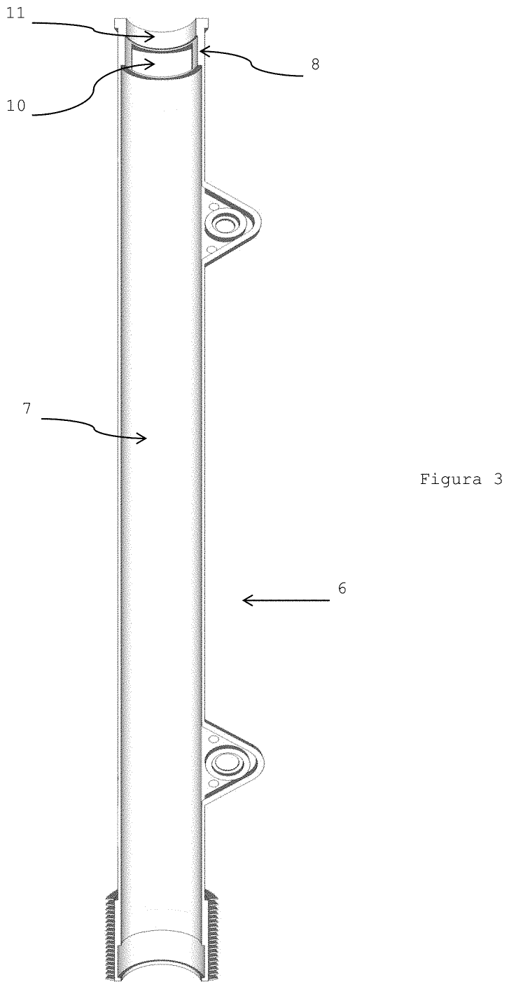

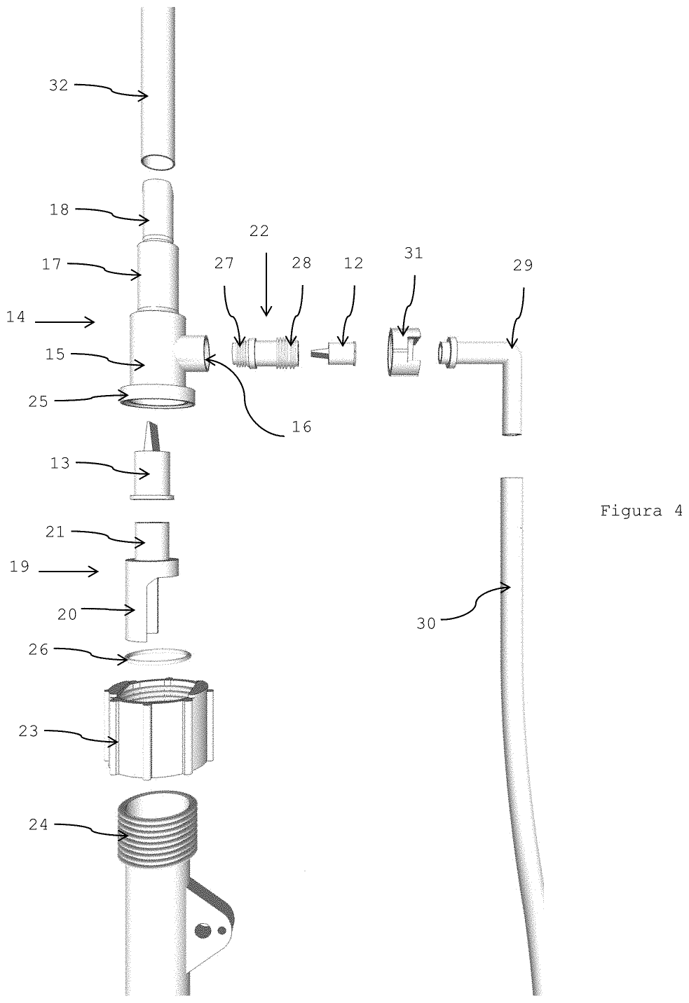

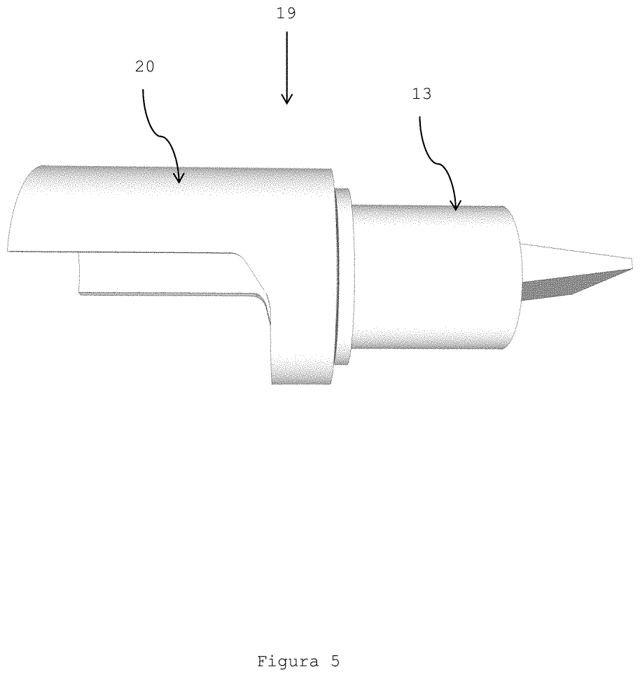

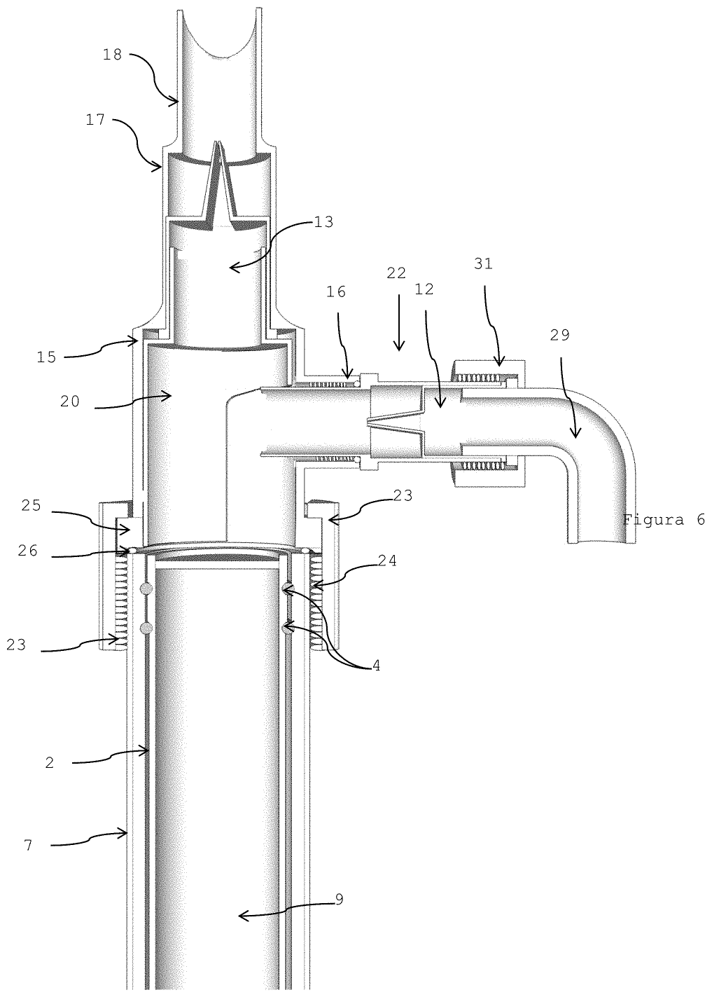

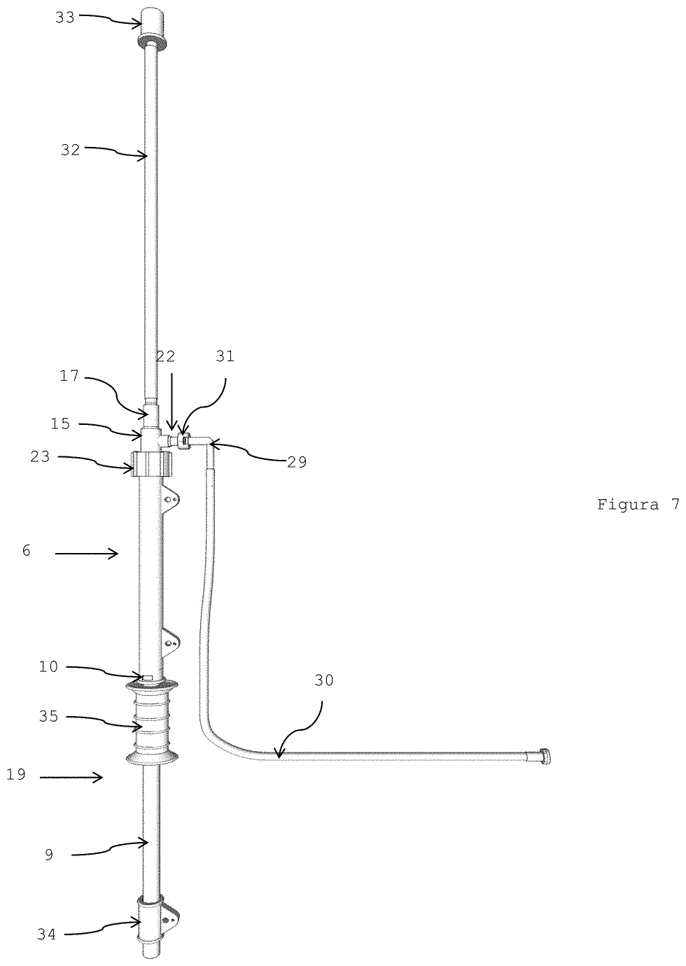

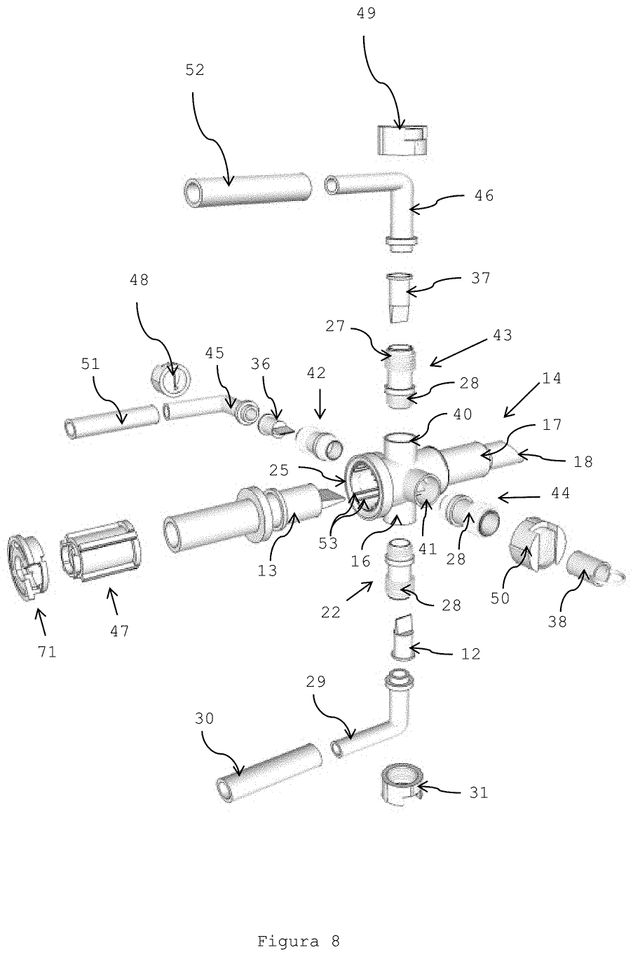

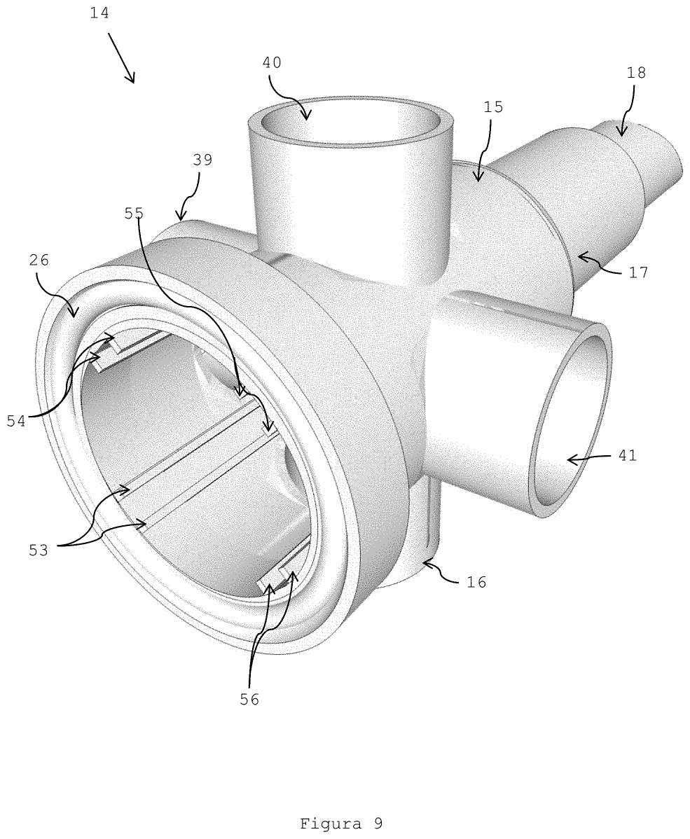

### DETAILED DESCRIPTION OF THE INVENTION

One of the main objects of the present invention is to provide an improved pump for the application of any type of fluids, whether the application of one or more fluids, simultaneously or at different times. The fluids that can be applied with the present pump, by way of example and not limitation, can be liquid fluids, such as water, all kinds of aqueous mixtures, paints, dyes, etc.; oil and oil based liquids; as well as gaseous fluids, such as air, gases, chemical mixtures to eliminate fires, among others.

The characteristic details of the pump for the application of fluids are clearly shown in the following detailed description, where the accompanying figures illustrate some of the preferred embodiments of the invention, so they should not be considered as a limitation for said invention.

The pump for the application of fluids of the present invention is formed by a piston, the shafts of a piston (1) and its respective sleeve (2), where the head (3) of the piston (1) is surrounded by two packing rings (4) separated from each other, to form a channel (5) between the separation of the packing rings (4), where a lubricant will be added to lubricate the piston; so that the packing rings (4) must have the sufficient dimensions to allow the sliding of the head (3), of the piston (1) inside the sleeve (2), without allowing the lubricant to spill out of the channel (5).

One of the improvements of the present pump is the fact of adding a tubular casing (6) to accommodate the sleeve (2) of the piston; where the interior of the casing (6) has three contiguous sections, from front to back, which differ from each other by their dimensions, which depend on the dimensions of the elements of the piston (1) to be housed; a first section (7) whose dimensions are sufficient to receive the sleeve (2); a second section (8) whose diameter is reduced according to the thickness of the walls of the sleeve (2), in such a way that the head (3) with its packing rings (4) have a place in the second section (8). A perforation (10) is provided in this second section (8) to apply the lubricant in the channel (5) of the head (3) of the piston (1), without the need to open the pump; and a third section (11) whose diameter is reduced according to the thickness of the projections of the packing rings (4), in such a way that the head (3) of the piston (1) does not leave the tubular casing (6), but allowing the rod (9) of the piston (1) to slide in and slide easily into the second section (8), third section (11) and the sleeve (2).

A set of valves is provided at the outlet end of the sleeve (2) of the piston, to suck and eject the fluid; where said set of valves comprises at least one inlet valve (12) and at least one outlet valve (13). Check type valves are preferred, although they may be of other types. Therefore, a first tubular valve container (14) with open ends, contains in its interior the outlet valve (13). In this case, the tubular valve container (14) is formed by three sections of diameters different from each other: the first section (15) being of greater diameter with a lateral perforation (16), following a second section (17) of intermediate diameter, and a third section (18) with smaller diameter.

A past tubular piece (19) is housed longitudinally within the first section (15) and second section (17); whereby said tubular piece (19) is also formed by two sections with dimensions apt to be housed in the first (15) and second section (17); where a first tubular section (20) whose longitudinal half is removed almost in its entirety, and a second section of smaller diameter (21) where the open circular end of the outlet valve (13) is fixed. That is, the tubular section (20) is housed inside the first section (15), and the section of smaller diameter (21) with the outlet valve (13) inserted, are housed longitudinally inside in the second section (17), but a part of the tip of the outlet valve (13) is housed in the smaller diameter section (18) of the tubular valve container (14), for a better application of the fluids.

In the lateral perforation (16) of the first section (15) of greater diameter, a second valve container (22) is coupled tubular and with open ends, where the inlet valve (12) is housed longitudinally, whose closed tip must to be projected towards the lateral perforation (16) of the first valve container (14).

It should be noted that the tubular piece (19) must be placed with its removed longitudinal half facing the same way as the lateral perforation (16), in such a way as to allow the accommodation of the upper end of the second valve container (22) and the passage of the fluids towards the sleeve (2), when they are sucked by the piston (1).

To join in a sealed manner the valve set with the piston outlet, any type of annular connectors and gaskets can be adapted. In this specific case, an omega union nut (23) with internal thread was used. Therefore, the tubular casing (6) is provided with an external thread (24) at the end where the piston outlet is, and a widening (25) is provided at the base of the first tubular valve container (14); in such a way that the omega union nut (23) surrounds the external threaded part (24) and the widening (25), and an annular gasket (26) is placed internally at the point where the piston outlet and the broadening make contact. (25), in order to connect and seal the piston with the valve set.

To connect the second tubular valve container (22), any type of connectors and rings or ring sealants can also be conditioned. For this example, the second tubular valve container (22) has an externally threaded area (27 and 28) at each of its ends, for engaging in the lateral perforation (16) of the first valve container (14) and to an corner connector (29), by means of a conventional nut (31), which will join it to a source of fluids (not illustrated) by means of a first conduit (30), such as for example a hose.

In the third section (18), a second conduit (32), such as a hose, is connected to receive the fluid that leaves the piston and leads it to a nozzle (33) for the final application of said fluid.

Finally a fastening means can be added to the pump in question, giving the user more practical handling. In this case, the most practical location of said clamping means is to place a first clamping means (34) on the free end of the rod (9) and a second clamping means (35) at a strategic point of the same rod (9).

In this way we obtain a pump to apply fluids in a simple manual manner without much effort, although a source of energy can be added, which allows the pump to operate in a motorized manner.

One of the embodiments of the pump of the present invention is to make the pump in question be able to manipulate or apply more than one fluid at a time. For this, the valves are added with more inlet valves, according to the number of fluids to be manipulated or applied, which should preferably be located equidistantly with each other. In this example, 2 more fluid inlet valves (36) and (37) were added, and an exhaust valve (38) to regulate the air pressure of the pump in question. This gives us a total of 3 fluid inlet valves (12, 36 and 37).

The way to integrate the other inlet valves (36 and 37) and the exhaust valve (38) is done in the way how the inlet valve (12) is integrated. Stated more specifically, the valve container (14) will have three more perforations (39, 40 and 41), in its first section (15) of greater diameter; in each perforation (39, 40 and 41) a third (42), fourth (43) and fifth (44) tube tubular container is coupled; where the third (42) and fourth (43) containers contain longitudinally, in their interior, the inlet valves (36) and (37), respectively; and the fifth container (44) has at its free end the exhaust valve (38). The tubular containers (42, 43 and 44) of valves have the same dimensions and configurations as those of the tubular container (22). In turn, the tubular containers (42 and 43) of inlet valves are each connected to their respective joints (45) and (46), by means of their respective conventional nuts (48 and 49), which will join them to each, with their respective sources of fluids (not illustrated) by means of their respective conduits (51) and (52), such as a hose. With respect to the valve container (44), a conventional nut (50) is used to attach said container (44) to the exhaust valve (38). In this example, the fluids that are being manipulated are: water, liquid soap and air, since the exhaust valves (38) are used to regulate the air pressure.

Inside the first section (15) of greater diameter, of the first valve container (14), there is at least two pairs of longitudinal rails, separated equidistantly from each other, to sustain and accommodate tubular piece which is a flow control piece (47) to select between several fluids. In this example, four pairs of rails (53, 54, 55 and 56) were distributed equidistantly to each other; whereby said flow control piece (47) can externally have, at least, 2 longitudinal protrusions distributed equidistantly to each other, where each longitudinal projection is inserted between the rails of the first section (15). The longitudinal protrusions also serve to delimit a cavity through which the fluids will flow towards the interior of the piston's sleeve (2).

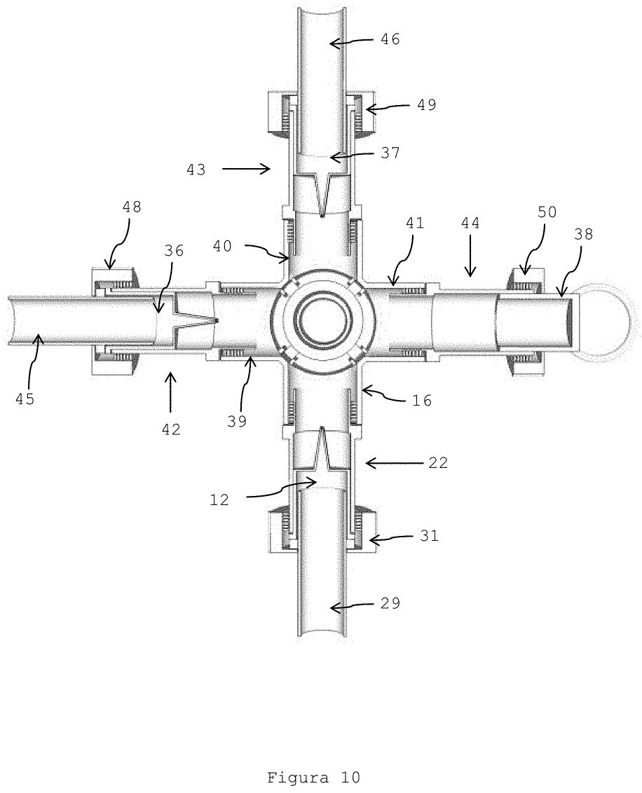

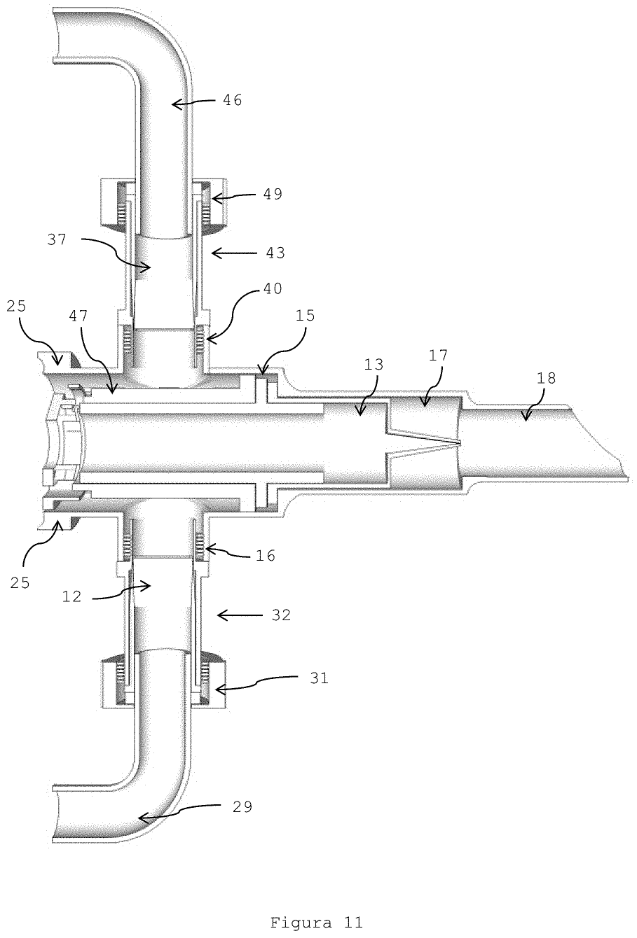

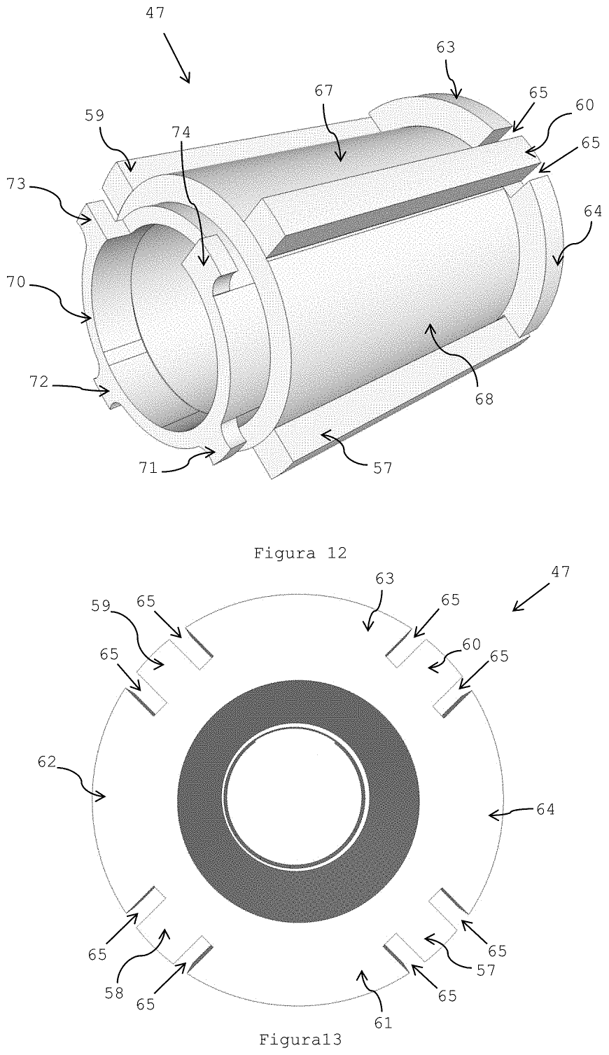

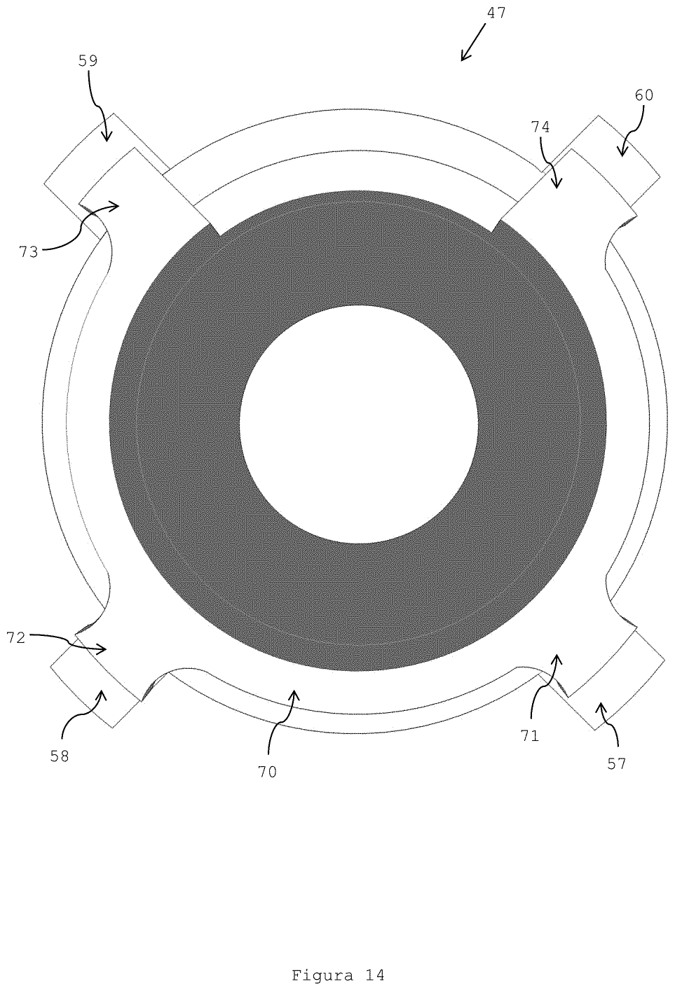

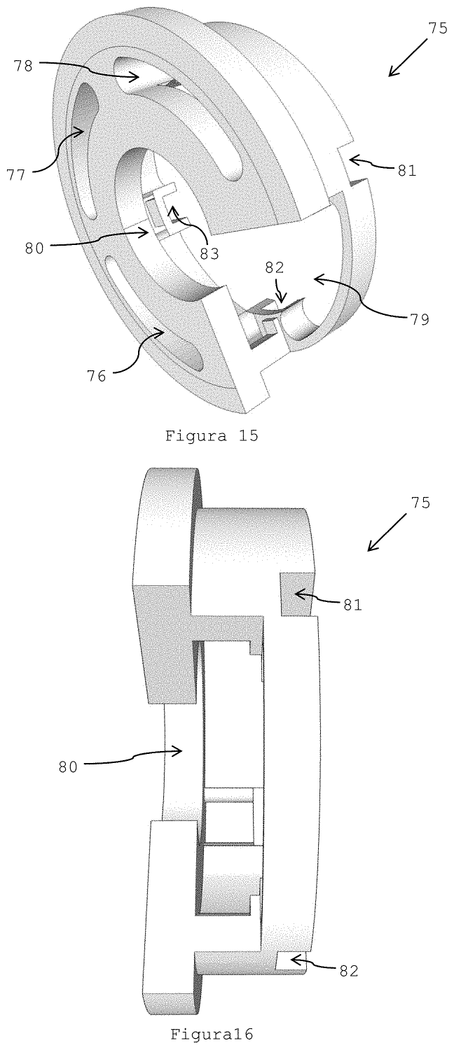

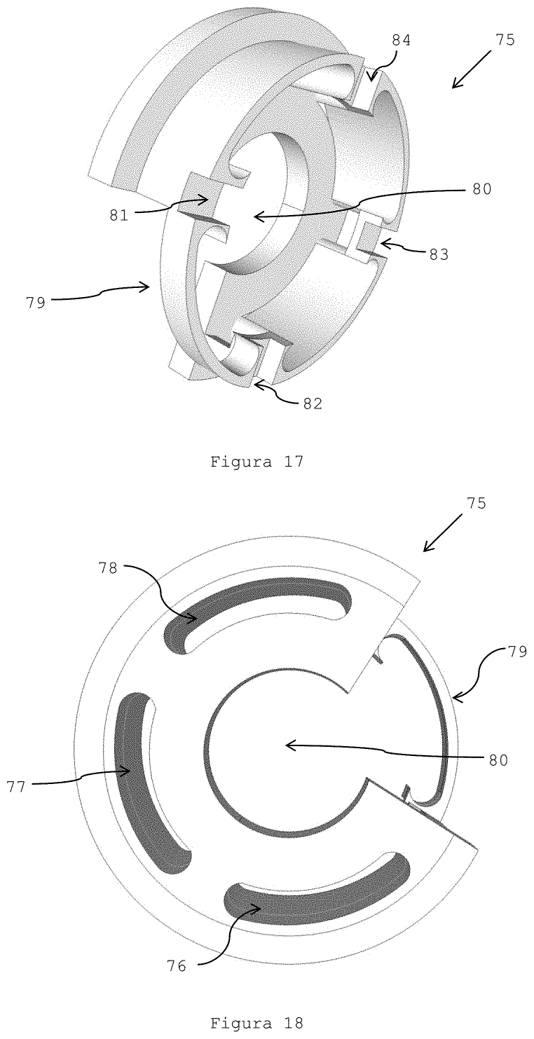

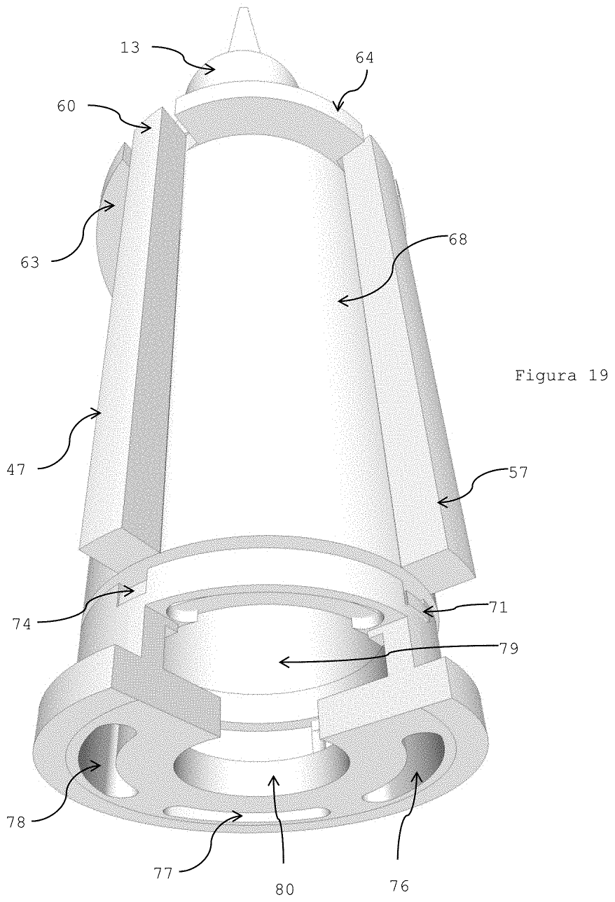

In this case, the flow control piece (47) was externally provided with 4 longitudinal protrusions (57, 58, 59 and 60) distributed equidistantly to each other. At one end of the tubular piece (47), its edges that are delimited between the longitudinal projections (57, 58, 59 and 60) project externally and perpendicularly with respect to the tubular body of said tubular piece (47), but without making contact with such longitudinal protrusions (57, 58, 59 and 60); in such a way that four transverse projections (61, 62, 63 and 64) are formed, but with a groove (65) between the transverse projections (61, 62, 63 and 64) and the longitudinal projections (57, 58, 59 and 60), giving a total of 8 slots (65) for this case, in these slot (65) a rail (53, 54, 55 and 56) are inserted and fixed in each one. Therefore, in this example, 4 cavities are configured (66 not illustrated, 67, 68 and 69 not shown). At the other end of the fluid controlling part (47) is projected concentrically internally, a tubular extension (70) of smaller diameter, which also has four transverse projections (71, 72, 73 and 74), which coincide its location with the longitudinal projections (57, 58, 59 and 60), respectively, but without making contact between them (see FIGS. 12 and 14).

A seal piece (75) is placed in the tubular extension (70) to choose which inlet valve to obstruct when it is desired to prevent the entry of some fluid into the piston. So in this case said piece is configured in such a way that it can be coupled to the tubular extension (70) of the fluid controlling part (47). Said piece-seal must have peripheral perforations to allow the entrance of the fluids and a central perforation to allow the exit of said fluids, because said piece serves as a seal for the control of the flow of the fluids. According to the configuration of the pump of the present invention, said seal piece (75) has three peripheral perforations (76, 77 and 78) according to the shape and dimensions of the cavities (66 not shown, 67, 68 and 69 not shown) to allow or interrupt the passage of one of the fluids; and a cavity (79) for blocking all peripheral perforations (76, 77 and 78) and completely preventing the entry of all fluids. At the opposite end where the peripheral cavities are, the part (75) has slots (81, 82, 83 and 84), where the projections (71, 72, 73 and 74), respectively, of the fluid control part (47) of the device are inserted.

Therefore, in order to block any of the peripheral perforations (76, 77 and 78) and the cavity (79), a projection (81) is provided on the free end of the head (3) of the piston (1), so that said projection (81) must have the same shape and dimensions sufficient to perfectly fit and seal said peripheral perforations (76, 77 and 78) and the cavity (79).

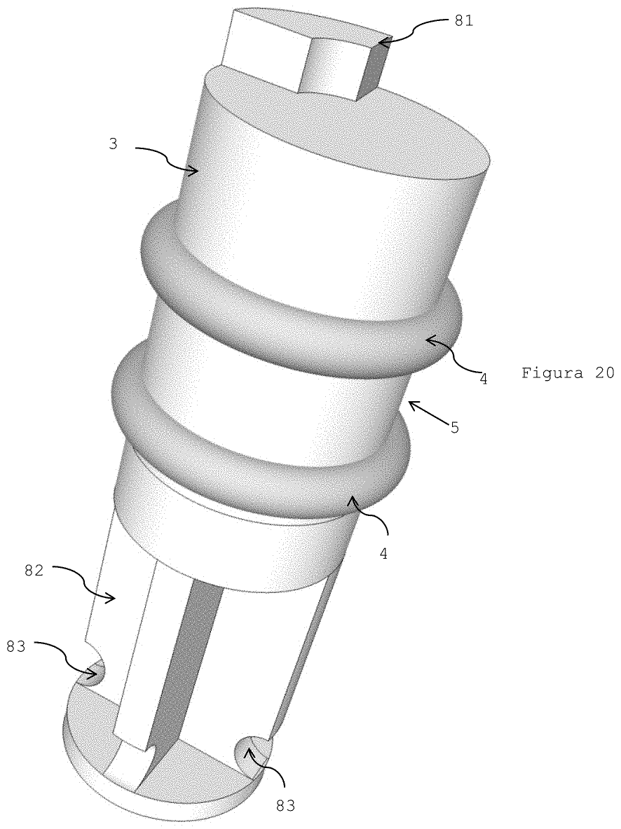

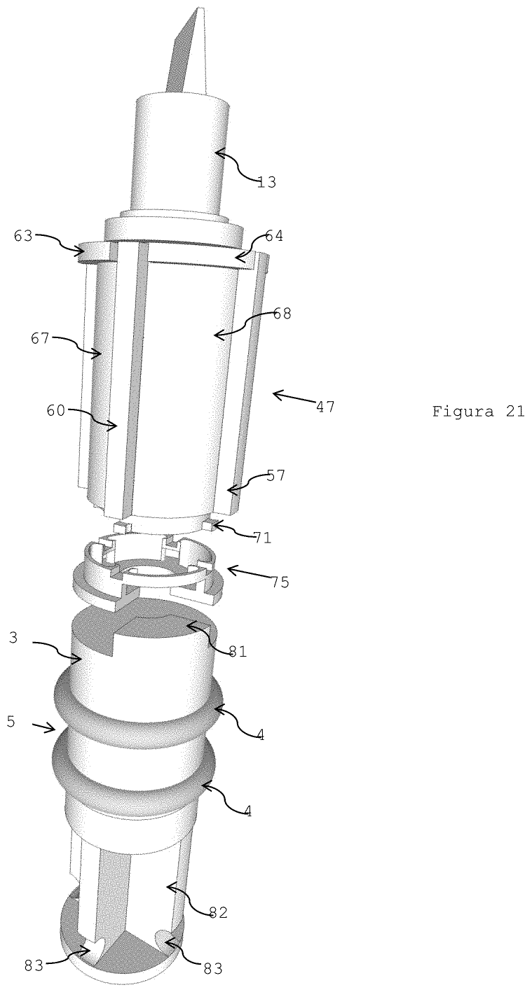

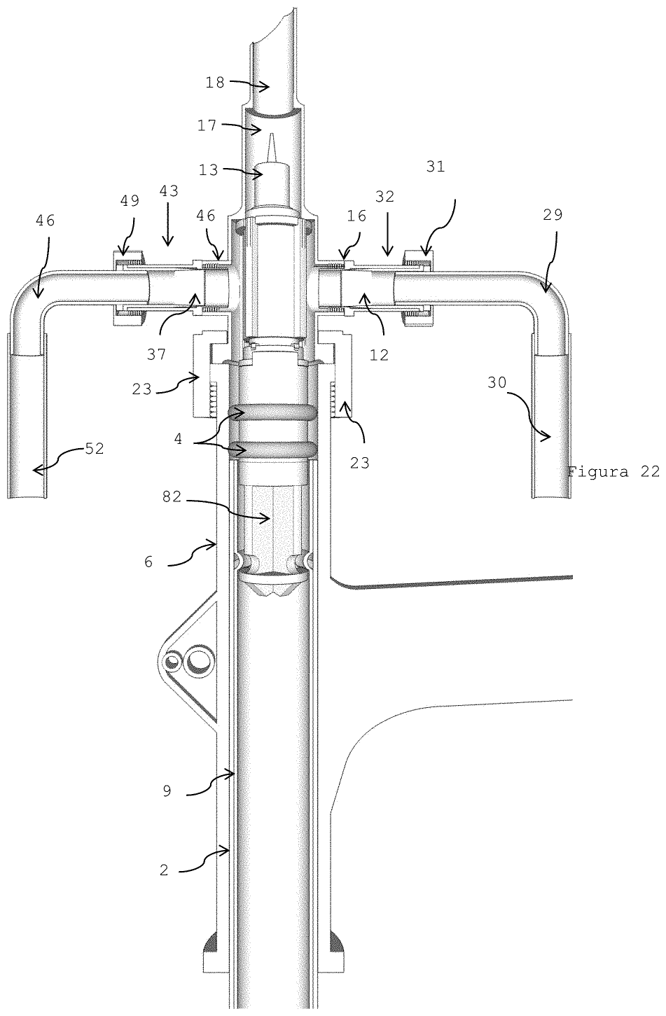

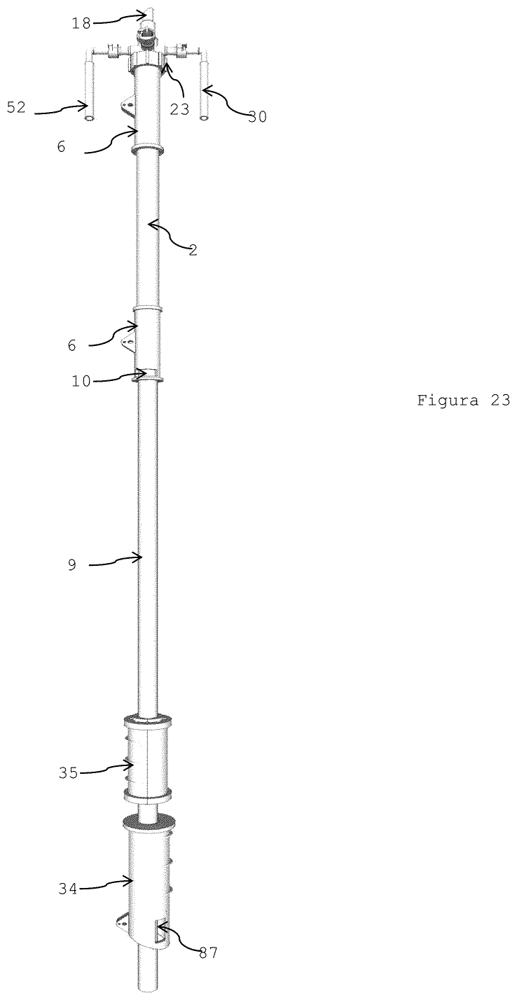

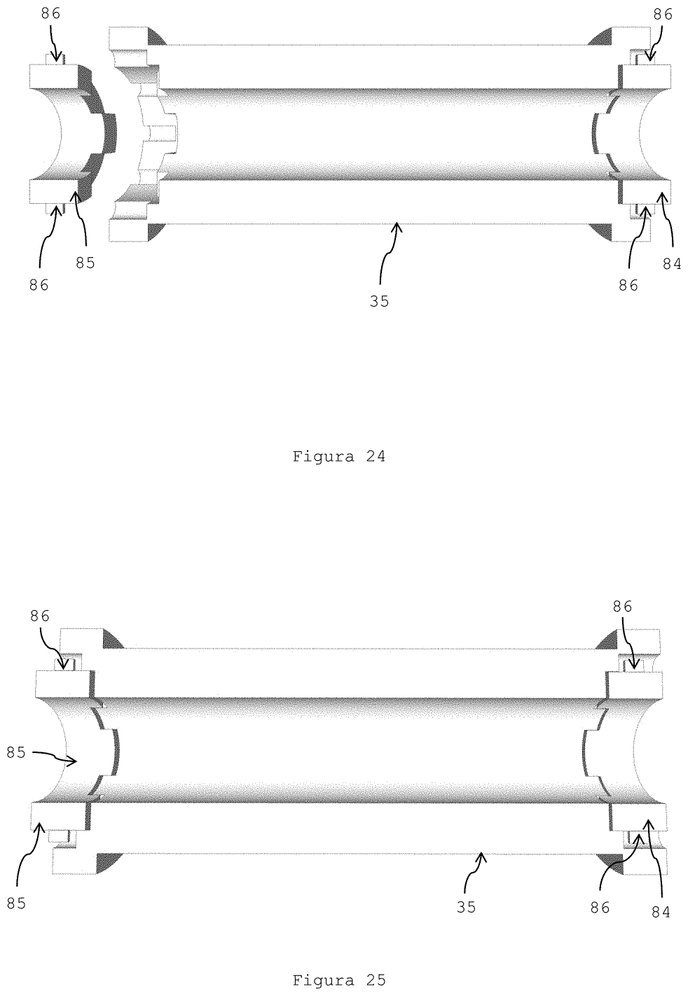

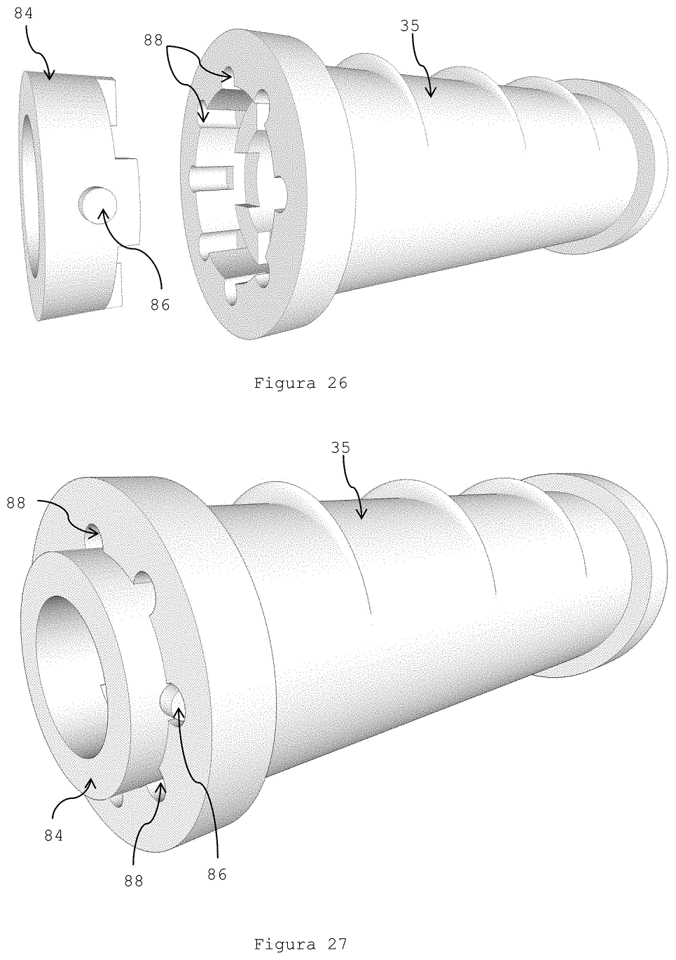

The way to securely join the rod (9) with the head (3) of the piston (1), can be a connector (82) that allows a durable connection. Such as a connector as that illustrated in FIGS. 20 and 21 which has a constriction (83) in its lower part, so that it applies a pressure on the part of the stem (9) that makes contact with said constriction (83) and said pieces remain well anchored together.

In this embodiment of the pump of the present invention, the fastening means (34 and 35) are modified to operate according to the requirements of this embodiment of said pump. In this case, the second securing means (35) is provided with two stop pieces (84 and 85) at each of its ends; wherein the front stop piece (84) is useful for controlling the displacement distance of the piston and especially for closing the peripheral perforations and the cavity (79) of the seal piece (75). For this purpose, this front stop piece (84) is circular and surrounds the rod (9), is assembled at the front end of the second clamping means (35), and has two projections (86) located equidistantly to each other; which are introduced into cavities (88) provided internally at the edge of the front end of the second fastening means (35). Therefore, the front end of said fastening means (35) has been modified in such a way that it can accommodate or couple the stop piece (84). In this way it suffices to turn the rod (9) with the support of the second holding means (35) and choose which peripheral perforation to block or if it is desired to block all the inlet valves, coupling the projection (81) in the cavity (79). The rear stop part (85), with the same configuration as the front stop piece (84), serves to prevent the grease from leaving the channel (5) formed by the rings (4). The first fastening means (34) only fits a wedge (87) to lock the piston in the chosen position. That is, once the projection is inserted in the chosen cavity of the seal-piece (75). The piston is fixed with the wedge and the user can release it from his hand and there is no risk of the piston changing position.

It should be noted that the pump in this mode, when it comprises a power source, such as a compressor, pressure energy source, etc., is not required to use the piston, since it will be sufficient with the energy source to introduce and eject fluids; in this case, the presence of the safety exhaust valve (38) is desirable. In contrast, when the piston is used, the use of the power source is optional and therefore the use of the safety exhaust valve (38) is also optional. This in order not to exceed the pump's pressure limit.

1. A pump for fluid application, comprising:
i) a piston (1) and its respective sleeve (2), wherein the head (3) of the piston (1) is surrounded by two ring-seals (4) separated from each other to form a channel (5) between the seal rings (4), where a lubricant is added to lubricate the piston;
ii) a tubular casing (6) for housing the piston sleeve (2), wherein the interior of the casing (6) has a first section (7) with sufficient dimensions to firmly accommodate the sleeve (2); a second section (8) whose diameter is reduced according to the thickness of the walls of the sleeve (2), and has a perforation (10) where the lubricant is applied in the channel (5); and a third section (11) whose diameter is reduced according to the thickness of the projections of the seal rings (4); and said casing (6) also has an external thread (24) at the end where the piston outlet is;
iii) a set of valves is provided at the outlet end of the piston's sleeve (2), for sucking and expelling, fluids; said set of valves is formed of:
a) an outlet valve (13);
b) a first tubular valve container (14) with open ends which houses the outlet valve (13), and said tubular valve container (14) is formed by three sections of different diameters: the first section (15) being of greater diameter with a lateral perforation (16), following a second section (17) of intermediate diameter, and a third section (18) with smaller diameter, and said first container (14) has a widening (25) in its base;
c) A tubular piece (19) is housed longitudinally inside the first section (15) and second section (17), whereby the tubular piece (19) is also formed by two sections with dimensions suitable to be housed in the first (15) and second section (17), where a first tubular section (20) has a longitudinal half removed in almost its entirety, and a second section of smaller diameter (21) where the open circular end of the outlet valve is fixed (13); leaving the first tubular section (20) housed longitudinally inside the first section (15), and the section of smaller diameter (21) with the outlet valve (13) inserted, in the second section (17), but one part of the tip of the outlet valve (13) is housed in the smaller diameter section (18) of the tubular valve container (14);
d) at least one inlet valve (12);
e) a second valve container (22) tubular and with open ends and with externally threaded areas (27 and 28) at each of its ends, is screwed perpendicularly, by means of one of its ends, into the lateral perforation (16) of the first section (15) of greater diameter of the first container (14), where the inlet valve (12) is housed longitudinally, the closed tip of which is projected towards the lateral perforation (16);
iv) a corner connector (29) is connected at the free end of the second valve container (22), to join the set of valves to:
v) a first conduit (30), which feeds the pump with fluid, and this in turn is connected to a source of fluids;
vi) a second conduit (32) is connected at the free end of the third section (18), of the first container (14), to receive the fluids leaving the piston and leading them to:
vii) a nozzle (33) for the final application of said fluid;
viii) connectors and annular gaskets, in a sealed manner, the set of valves with the outlet of the piston, and the second valve container (22) with the corner joint (29); and
ix) at least one means for securing the pump is provided on the piston rod (9).

2. The pump of the preceding claim, wherein the packing rings (4) must have the sufficient dimensions to allow the sliding of the head (3), of the piston (1), inside the sleeve (2), without allowing the spillage of the lubricant outside the channel (5).

3. The pump according to claim 1, wherein the tubular piece (19) must be placed with its longitudinal half removed downward, in such a way as to accommodate the upper end of the second valve container (22) and the passage of the fluids towards the sleeve (2), when they are sucked by the piston (1).

4. The pump according to claim 1, where the connector that connects the set of valves with the outlet of the piston is an omega union nut (23) with internal thread, which surrounds the external threaded part (24) of the casing (2) and the widening (25) of the first valve container (14), and an annular gasket (26) is placed internally at the point where the piston outlet and the broadening (25) come in contact.

5. The pump according to claim 1, wherein the connector for joining the second tubular valve container (22), with the corner connector (29), is a conventional nut (31).

6. The pump, as claimed in claim 1, wherein the means for fastening the pump, is formed of a first clamping means (34) on the free end of the rod (9) and a second clamping means (35) at a strategic point of the same rod (9) of the piston (1).

7. The pump of claim 1, characterized in that it optionally comprises an energy source, to operate said pump in a motorized manner.

8. The pump according to claim 1, characterized in that the valve assembly further comprises:
i) a second (36) and third (37) fluid inlet valve;
ii) a third (42) and fourth (43) tubular valve container for longitudinally containing in its interior the second (36) and third (37) fluid inlet valve, respectively, which are joined in the first section (15) of the first tubular valve container (14);
iii) an safety exhaust valve (38) to regulate the air pressure of the pump in question;
iv) a fifth tubular valve container (44) for containing at its free end the exhaust valve (38), which is also joined in the first section (15) of the first valve container (14);
v) a tubular piece passed (47) to control the entrance of the fluids, is housed longitudinally inside the first section (15) of the first valve container (14); and
vi) a seal-piece (75) is placed on the end of the fluid controlling part (47) that is projected towards the outlet of the sleeve (2) of the piston, the function of this piece is to allow the user to turn the handle and thus choose which fluid inlet to clog when the user wants to obstruct, partially or totally, the entry of a particular fluid into the piston.

9. The pump of claims 1 and 8, wherein the first valve container (14) comprises:
i) three more perforations (39, 40 and 41), in its first section (15) of greater diameter; and in each perforation (39, 40 and 41) the third (42), fourth (43) and fifth (44) tube tubular container, respectively, is coupled where such containers (42, 43 and 44) have the same configuration as container(22); in turn, the tubular containers (42 and 43) are each connected with their respective corner connector (45) and (46), by means of their respective conventional nuts (48 and 49), which will join them each, with their respective sources of fluids through their respective conduits (51) and (52); and
ii) at least two pairs of rails, spaced equidistant from each other, arranged longitudinally inside the first section (15) of greater diameter, leaving a pair of rails between the perforations (16, 39, 40 and 41); in order to fasten to the tubular piece (47).

10. The pump according to the preceding claim, where the number of pairs of rails are four (53, 54, 55 and 56) distributed equidistantly to each other, and located between the perforations (16, 39, 40 and 41).

11. The pump of claims 8, and 9, wherein the flow controlling piece (47) has externally, at least, two longitudinal protrusions distributed equidistantly, which are introduced between the rails and delimit, at least, two cavities where the fluids will pass; in one of the ends of the tubular piece (47), its edges that are delimited between the longitudinal projections project externally and perpendicularly with respect to the tubular body of the tubular piece (47) but without making contact with such longitudinal projections; and at the other end of the fluid controlling part (47) is projected in an internal concentric manner, a tubular extension (70) of smaller diameter, which also has the same number of transversal projections, which coincide their location with the longitudinal projections, respectively, but without making contact between them.

12. The pump according to claims 8 to 11, where the flow controlling piece (47) has four longitudinal projections (57, 58, 59 and 60) externally distributed equidistantly to each other, originating four edges delimited between the longitudinal projections (57, 58, 59 and 60); four transverse projections (61, 62, 63 and 64) are formed, but with a groove (65) between the transverse projections (61, 62, 63 and 64) and the longitudinal projections (57, 58, 59 and 60), giving a total of 8 grooves (65), and in these grooves (65) are inserted and fixed in each a rail (53, 54, 55 and 56); configuring 4 cavities (66 not illustrated, 67, 68 and 69 not illustrated) where the fluids will enter the piston.

13. The pump according to claim 11, wherein the number of projection of the tubular extension (70) of smaller diameter, is of four transverse projections (71, 72, 73 and 74), which coincide their location with the longitudinal projections (57, 58, 59 and 60), respectively, of the piece (47), but without making contact between them.

14. The pump of claims 8, 11, 12 and 13, wherein said seal piece (75) is configured in such a way that it can be coupled to the tubular extension (70) of the fluid controlling part (47); whereby said seal piece has peripheral perforations to allow the entrance of the fluids and a central perforation to allow the exit of said fluids, so that such seal piece (75) serves as a seal for the control of the flow of the fluids.

15. The pump according to the preceding claim, wherein said seal piece (75) has:
a. three peripheral perforations (76, 77 and 78) according to the shape and dimensions of the cavities (66 not shown, 67, 68 and 69 not shown) of the controlling piece (47), to allow or interrupt the passage of one of the fluids;
b. a cavity (79) for blocking all peripheral perforations (76, 77 and 78) and completely preventing the entry of fluids;
c. and at the opposite end where the peripheral cavities are, the piece (75) has slots (81, 82, 83 and 84), where the fluid control piece's(47) projections (71, 72, 73 and 74) are inserted.

16. The pump according to claim 8, wherein the valve container (44) is joined to the exhaust valve (38), by means of a conventional nut (50).

17. The pump of claims 1, 14 and 15, characterized in that at the free end of the head (3) of the piston (1) there is further provided a projection (81), for blocking any of the peripheral perforations (76), 77 and 78) and the cavity (79), of the seal piece (75); whereby said projection (81) must have the same shape and dimensions to perfectly fit and seal said peripheral perforations (76, 77 and 78) and the cavity (79).

18. The pump as claimed in claims 1 and 6, where the second securing means (35) is provided with two stop pieces (84 and 85) at each of its ends; wherein the front stop piece (84) is useful for controlling the displacement distance of the piston and especially for closing the peripheral perforations and the cavity (79) of the seal piece (75); for this, this front stop piece (84) is circular and surrounds the rod (9) and is assembled at the front end of the second holding means (35), and has two projections (86) located equidistantly to each other, which are introduced into cavities (88) provided internally at the edge of the front end of the second fastening means (35);
therefore, the front end of said fastening means (35) has been modified in such a way as to house or engage the stop piece (84); the rear stop part (85), of the same configuration to the front stop piece (84), serves to prevent the grease from leaving the channel (5) formed by the rings (4).

19. The pump according to claims 1 and 6, wherein the first securing means (34) is fitted with a wedge (87) to fix the piston in the chosen position, once the projection (81) is inserted in the chosen cavity of the seal piece (75).

20. The pump according to claims 8 to 19, characterized in that it optionally comprises an energy source, such as a compressor, or source of pressure energy.
